(19) United States
(12) Patent Application Publication
(10) Pub. No.: US 2021/0152907 A1
(43) Pub. Date: May 20, 2021

(54) SPEAKER APPARATUS

(71) Applicant: SDS Asia Limited, BVI #1748971, Hong Kong (CN)

(72) Inventor: Jason Koranda, Omaha, NE (US)

(73) Assignee: SDS Asia Limited, BVI #1748971, Hong Kong (CN)

(21) Appl. No.: 17/104,493

(22) Filed: Nov. 25, 2020

Related U.S. Application Data
(63) Continuation-in-part of application No. 29/701,298, filed on Aug. 9, 2019.
(60) Provisional application No. 62/962,043, filed on Jan. 16, 2020.
(60) Provisional application No. 62/959,016, filed on Jan. 9, 2020.

(51) Int. Cl. H04R 1/02; H04R 1/44

(52) U.S. Cl. CPC H04R 1/026; H04R 1/44

(57) ABSTRACT

A system and a speaker apparatus. The system may include a speaker apparatus. The speaker apparatus may include a speaker apparatus body and a removable base. The removable base may have a cavity formed within the removable base. The removable base may optionally have at least two side holes and a bottom hole. The at least two side holes and the bottom hole may allow for a flow of a water to flow into and out of the cavity.

### CROSS-REFERENCE TO RELATED APPLICATIONS

This application claims priority to: (a) U.S. patent application Ser. No. 29/701,298, filed on Aug. 9, 2019, (b) U.S. Patent Application No. 62/959,016, filed on Jan. 9, 2020, and (c) U.S. Patent Application No. 62/962,043, filed on Jan. 16, 2020, which are herein incorporated by reference in their entirety.

### BACKGROUND

Speakers have long been used for playing music and audio. Portable speakers typically have unibody form. Many speakers are not well suited for use in water.

### SUMMARY

In one aspect, embodiments of the inventive concepts disclosed herein are directed to a system. The system may include a speaker apparatus. The speaker apparatus may include a speaker apparatus body and a removable base. The removable base may have a cavity formed within the removable base.

In a further aspect, embodiments of the inventive concepts disclosed herein are directed to a speaker apparatus. The speaker apparatus may include a speaker apparatus body and a removable base. The removable base may have a cavity formed within the removable base.

### BRIEF DESCRIPTION OF THE DRAWINGS

Implementations of the inventive concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 is a view of an exemplary embodiment of a system including a speaker apparatus according to the inventive concepts disclosed herein.

FIG. 2 is a view of an exemplary embodiment of a system including a speaker apparatus according to the inventive concepts disclosed herein.

FIG. 3 is a view of an exemplary embodiment of a system including a speaker apparatus according to the inventive concepts disclosed herein.

FIG. 4 is a view of an exemplary embodiment of a system including a speaker apparatus according to the inventive concepts disclosed herein.

FIG. 5 is a view of an exemplary embodiment of a system including a speaker apparatus according to the inventive concepts disclosed herein.

FIG. 6 is a view of an exemplary embodiment of a system including a speaker apparatus according to the inventive concepts disclosed herein.

FIG. 7 is a view of an exemplary embodiment of a system including a speaker apparatus according to the inventive concepts disclosed herein.

FIG. 8 is a view of an exemplary embodiment of a system including a speaker apparatus according to the inventive concepts disclosed herein.

FIG. 9 is a view of an exemplary embodiment of a system including a speaker apparatus according to the inventive concepts disclosed herein.

FIG. 10 is a view of an exemplary embodiment of a system including a speaker apparatus according to the inventive concepts disclosed herein.

FIG. 11 is a view of an exemplary embodiment of a system including a speaker apparatus according to the inventive concepts disclosed herein.

FIG. 12 is a view of an exemplary embodiment of a system including a speaker apparatus according to the inventive concepts disclosed herein.

FIG. 13 is a view of an exemplary embodiment of a system including a speaker apparatus according to the inventive concepts disclosed herein.

FIG. 14 is a view of an exemplary embodiment of a system including a speaker apparatus according to the inventive concepts disclosed herein.

FIG. 15 is a view of an exemplary embodiment of a system including a speaker apparatus according to the inventive concepts disclosed herein.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein are directed to a speaker apparatus and system. The speaker apparatus may be configured to play music received from a mobile computing device. In some embodiments, the speaker apparatus may be portable and may float in water.

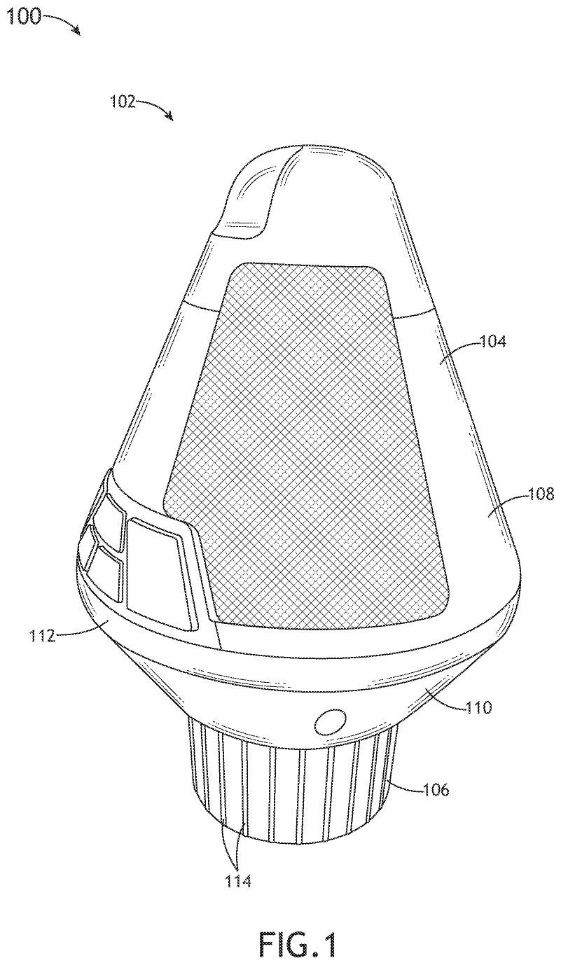

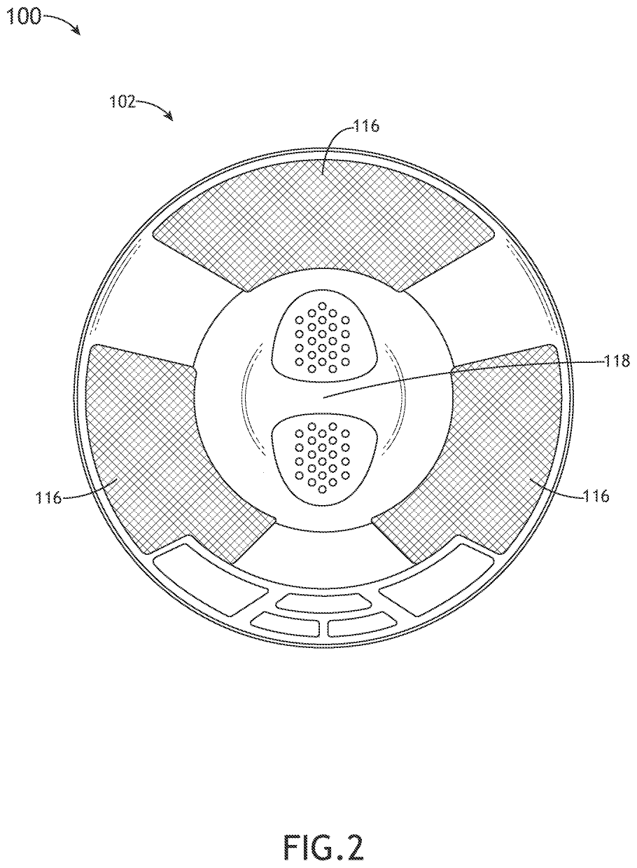

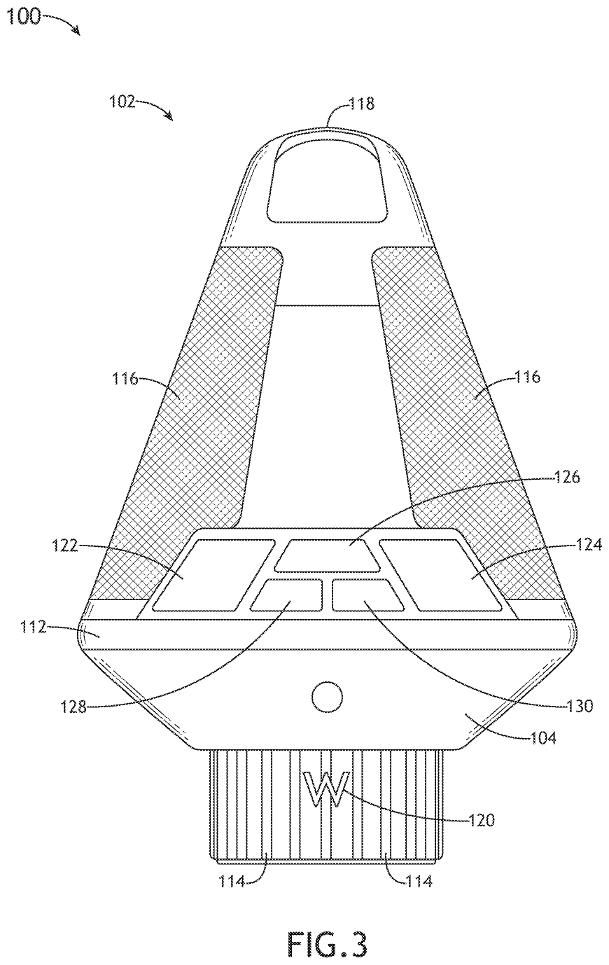

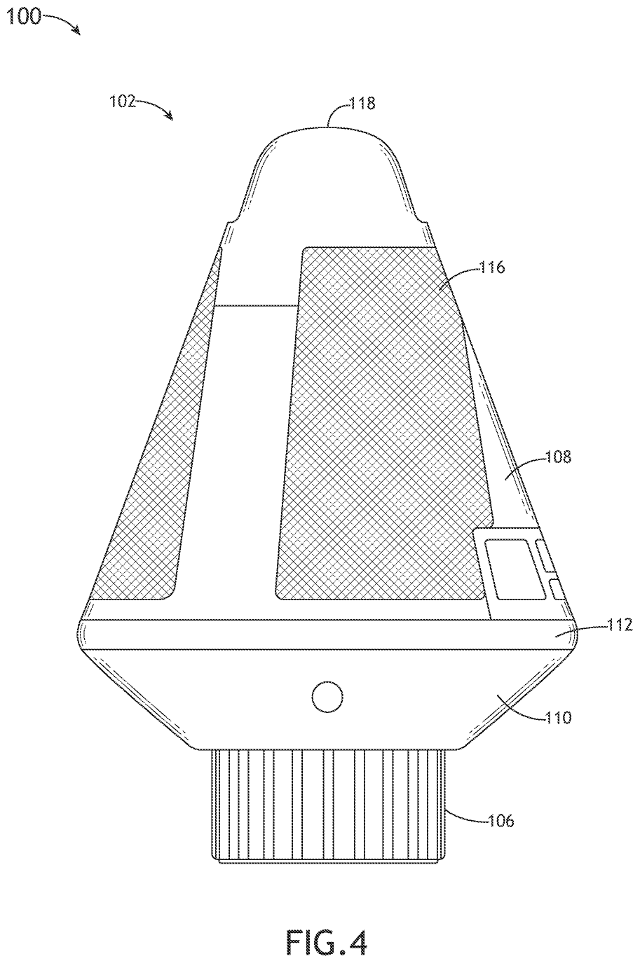

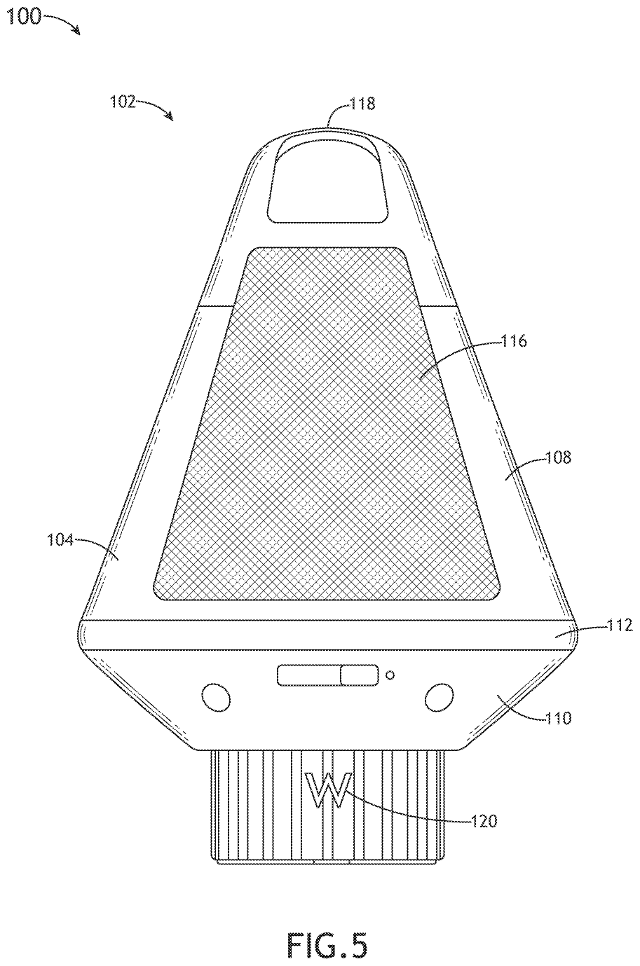

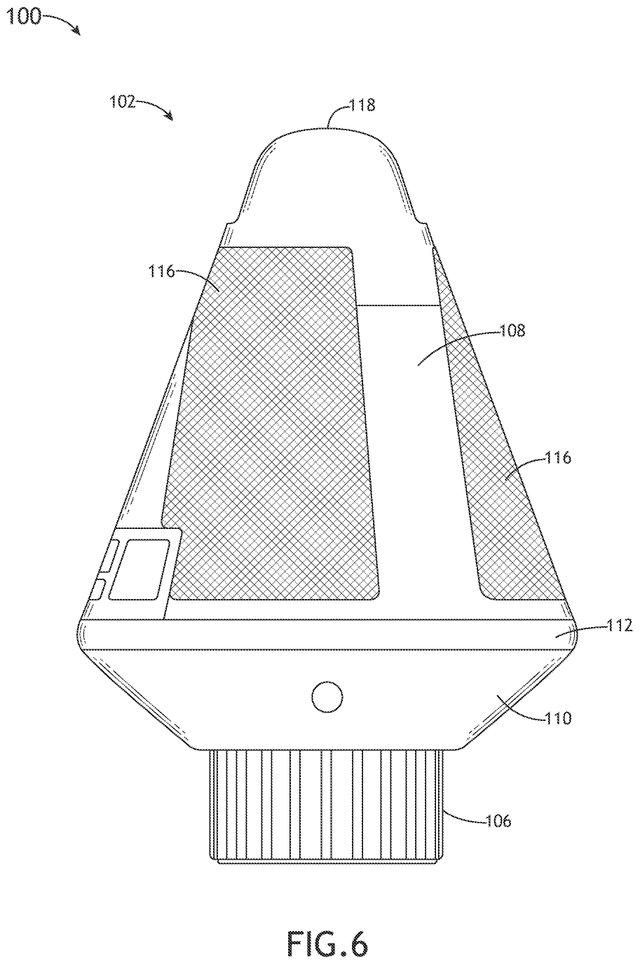

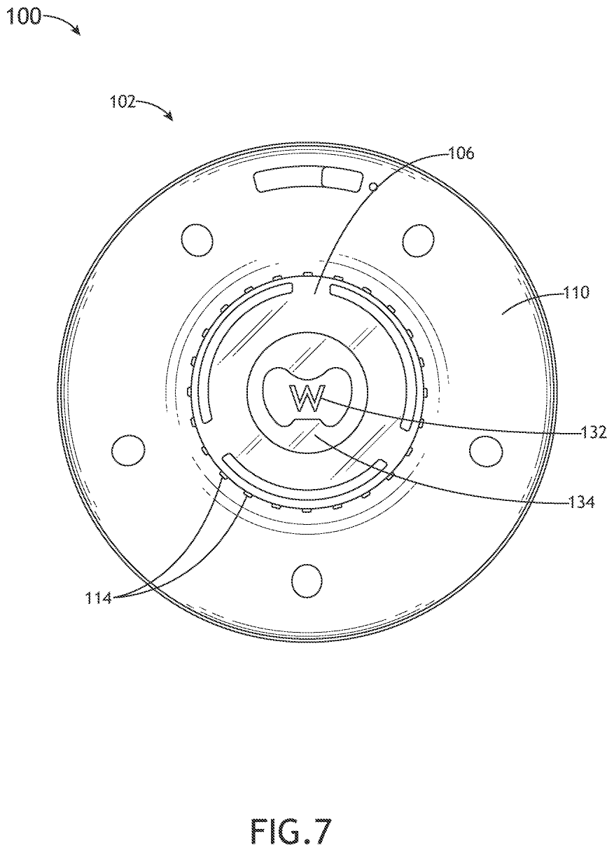

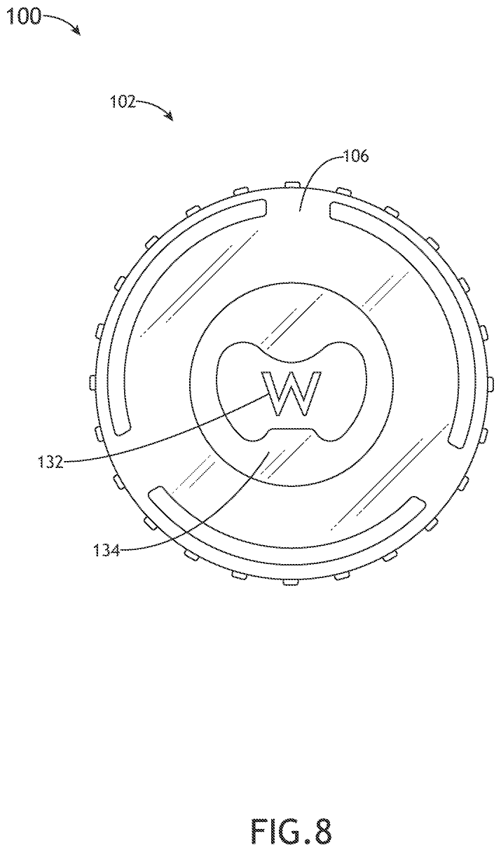

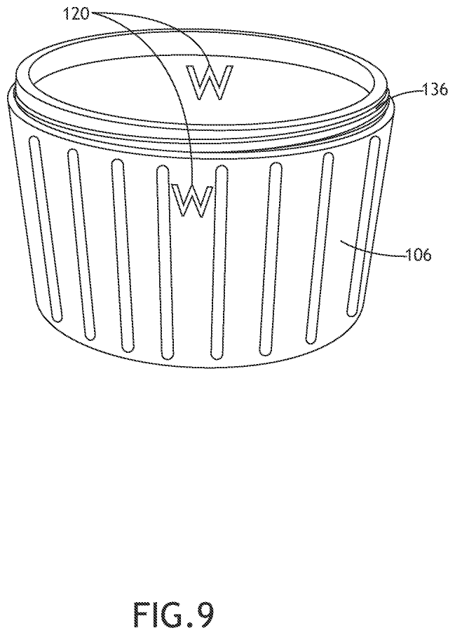

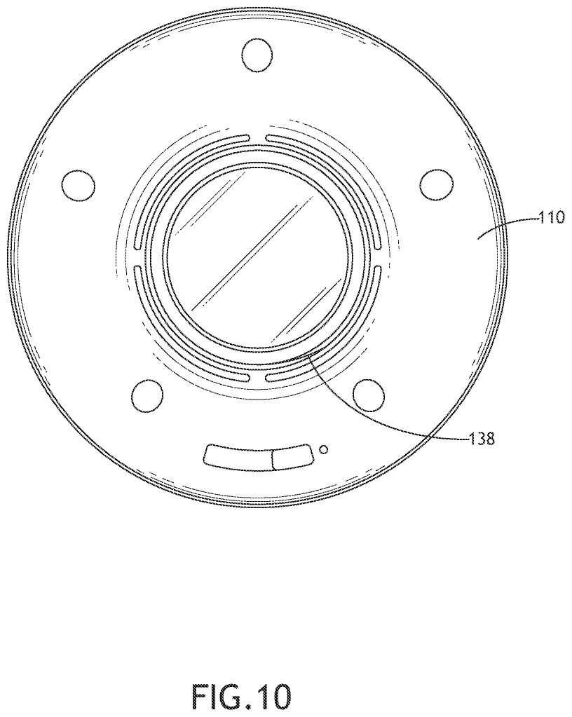

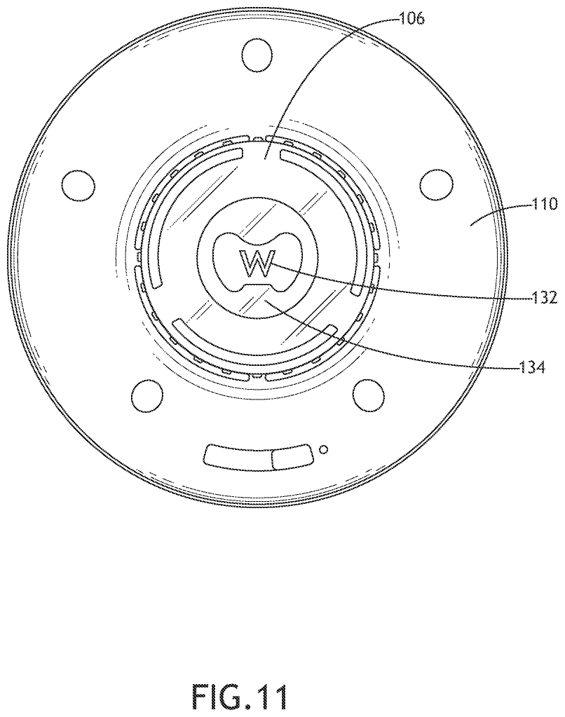

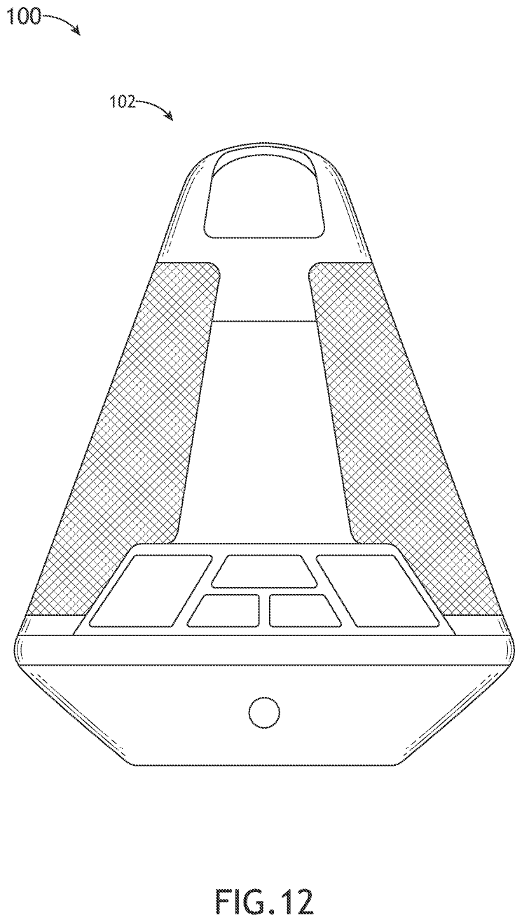

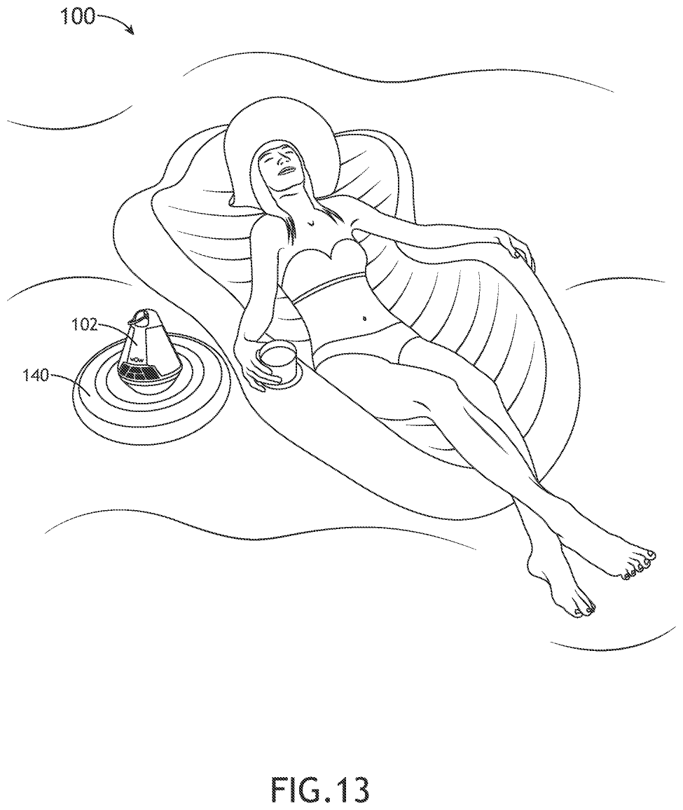

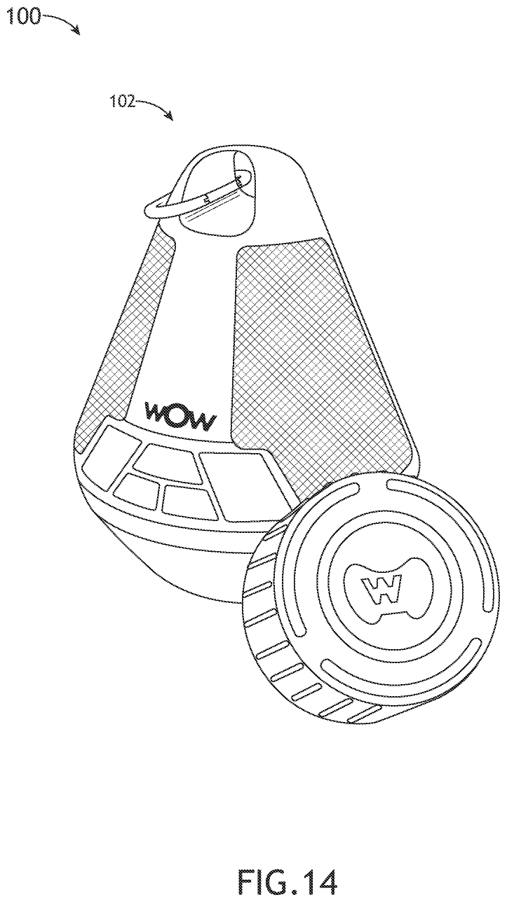

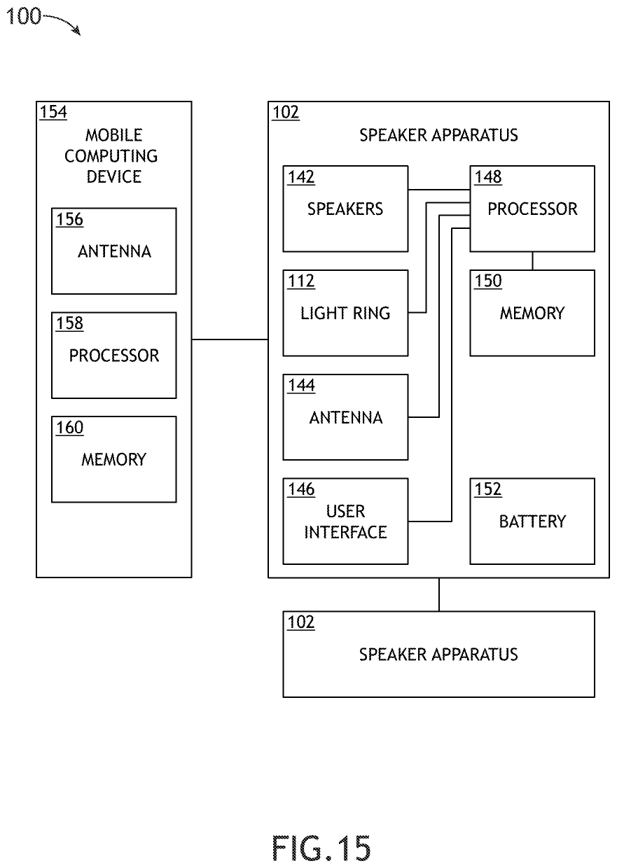

Referring now to FIGS. 1-15, exemplary embodiments of a system 100 including a speaker apparatus 102 according to the inventive concepts disclosed herein are depicted. For example, the system 100 may include at least one speaker apparatus 102, at least one an inflatable flotation apparatus 140 (as shown in FIG. 13), and/or at least one mobile computing device 154 (as shown in FIG. 15), some or all of which may be communicatively coupled at any given time.

The speaker apparatus 102 may include a speaker apparatus body 104 and a removable base 106. The speaker apparatus body 104 may have an exterior shape generally defined by a cone portion 108 and an inverted cone portion 110, wherein the inverted cone portion 110 may lack a tip portion, wherein the removable base 106 may be configured to removably attach to the inverted cone portion 110. The speaker apparatus body 104 may be water-resistant, shock-resistant, and/or dust-resistant. The speaker apparatus body 104 may include a handle 118 at a top of the speaker apparatus body 104. The speaker apparatus body 104 may be formed at least in part by plastic.

The removable base 106 may be configured to attach and be removed from a bottom of the inverted cone portion 110 of the speaker apparatus body 104. For example, the removable base 106 may include threads 136 configured to screw into corresponding threads 138 of the bottom of the inverted cone portion 110. The removable base 106 may have a cavity formed within the removable base 106. The removable base may have at least one (e.g., two or more) side holes 120 and at least one bottom hole 132. The at least one side hole 120 and the bottom hole 132 may allow for a flow of a water to flow into and out of the cavity. The at least one side hole 120 and the bottom hole 132 may have any suitable shapes, such as round or W-shaped. For example, when the speaker apparatus 102 floats in water, the cavity of the removable base 106 may fill with water, and when the speaker apparatus 102 is removed from water, the water may drain out of the cavity via the bottom hole 132. The ability for the cavity to fill with water may improve the upright stability of the speaker apparatus 102 when floating in water. The removable base 106 may have an exterior shape generally defined by a cylinder. In some embodiments, a diameter of the cylinder may be less than a diameter of a circle formed by abutting portions of the cone portion 108 and the inverted cone portion 110. In some embodiments, an exterior of the removable base 106 may include ridges (e.g., vertical ridges 114). In some embodiments, the removable base 106 may include a bottle opener 134 (e.g., which may be formed of metal) positioned at a bottom of the removable base 106. In some embodiments, the removable base 106 may fit into the inflatable flotation apparatus 140 (as shown in FIG. 13) and/or a cup holder. The removable base 106 may be formed at least in part by plastic.

The speaker apparatus 102 and/or the speaker apparatus body 104 may include at least one speaker 142, at least one light ring 112, at least one antenna 144, at least one user interface 146, at least one processor 148, at least one memory 150, and/or at least one battery 152, some or all of which may be communicatively coupled at any given time.

The at least one processor 148 may be implemented as any suitable type and number of processors. For example, the at least one processor 148 may include at least one general purpose processor (e.g., at least one central processing unit (CPU)), at least one digital signal processor (DSP), at least one application specific integrated circuit (ASIC), and/or at least one field-programmable gate array (FPGA). The at least one processor 148 may be configured to perform (e.g., collectively perform if more than one processor) any or all of the operations disclosed throughout. The processor 148 may be configured to run various software applications or computer code stored (e.g., maintained) in a non-transitory computer-readable medium (e.g., memory 150) and configured to execute various instructions or operations. For example, the processor 148 may be configured to: receive audio data from the mobile computing device 154 via the antennas 144, 156; output audio signals to the speakers 142; control operation of the light ring 112 to output multicolor light; and/or receive user inputs via the user interface 146.

For example, the speaker apparatus body 104 may include at least three speakers 142 configured to output 360-degree audio. The speaker apparatus body 104 may include speakers covers 116 configured to cover the speakers 142. The speakers 142 may be configured to output audio (e.g., music) received from the processor 148 and/or the mobile computing device 154.

For example, the speaker apparatus body 104 may include the light ring 112. For example, the light ring 112 may include multicolor light emitting diodes (LEDs) and may be configured to output 360-degree multicolor light. For example, the light ring 112 may be positioned around an exterior of the speaker apparatus body 104 where the cone portion 108 abuts the inverted cone portion 110. The light output from the light ring 112 may be controlled by the processor 148 and may be synchronized to music.

For example, the antenna 144 may be configured to transmit and/or receive signals from the mobile computing device 154 and/or another speaker apparatus 102. In some embodiments, the antenna 144 may be a Bluetooth antenna. The speaker apparatus 102 may be configured to wirelessly communicate via the antenna 144 with the mobile computing device 154 and/or another speaker apparatus 102. The speaker apparatus 102 may be configured to pair with the mobile computing device 154 and/or another speaker apparatus 102.

For example, the speaker apparatus body 104 may include a user interface 146. The user interface may be any suitable user interface (e.g., a display (e.g., a touchscreen display, a voice recognitions system (e.g., including a microphone and a processor), and/or physical buttons)). For example, the user interface 146 may include user interface buttons (e.g., a power button 126, a volume up button 124, a volume down button 122, a Bluetooth button 128 (e.g., configured to initiate a Bluetooth pairing process with the mobile computing device 154 when pressed), and/or a light ring button 130 (e.g., configured to control operation of the light ring 112)).

The speaker apparatus 102 may be configured to wirelessly communicate with the mobile computing device 154. The mobile computing device 154 may include at least one antenna 156, at least one processor 158, at least one memory 160, at least one user interface, and/or other components commonly found in a mobile computing device, some or all of which may be communicatively coupled at any given time. In some embodiments, the mobile computing device 102 may be a tablet computing device, a laptop computing device, or a phone computing device. The mobile computing device 154 may be configured to pair with at least one speaker apparatus 102 and output audio data to the speaker apparatus 102. In some embodiments, the mobile computing device 154 may be configured to pair with and output audio data to multiple speaker apparatuses 102. The at least one processor 158 may be implemented as any suitable type and number of processors. For example, the at least one processor 158 may include at least one general purpose processor (e.g., at least one central processing unit (CPU)), at least one digital signal processor (DSP), at least one application specific integrated circuit (ASIC), and/or at least one field-programmable gate array (FPGA). The at least one processor 158 may be configured to perform (e.g., collectively perform if more than one processor) any or all of the operations disclosed throughout. The processor 158 may be configured to run various software applications or computer code stored (e.g., maintained) in a non-transitory computer-readable medium (e.g., memory 160) and configured to execute various instructions or operations.

As will be appreciated from the above, embodiments of the inventive concepts disclosed herein may be directed to a speaker apparatus and system.

As used throughout and as would be appreciated by those skilled in the art, “at least one non-transitory computer-readable medium” may refer to as at least one non-transitory computer-readable medium (e.g., at least one computer-readable medium implemented as hardware; e.g., at least one non-transitory processor-readable medium, at least one memory (e.g., at least one nonvolatile memory, at least one volatile memory, or a combination thereof; e.g., at least one random-access memory, at least one flash memory, at least one read-only memory (ROM) (e.g., at least one electrically erasable programmable read-only memory (EEPROM)), at least one on-processor memory (e.g., at least one on-processor cache, at least one on-processor buffer, at least one on-processor flash memory, at least one on-processor EEPROM, or a combination thereof), or a combination thereof), at least one storage device (e.g., at least one hard-disk drive, at least one tape drive, at least one solid-state drive, at least one flash drive, at least one readable and/or writable disk of at least one optical drive configured to read from and/or write to the at least one readable and/or writable disk, or a combination thereof), or a combination thereof).

As used throughout, “at least one” means one or a plurality of; for example, “at least one” may comprise one, two, three, . . . , one hundred, or more. Similarly, as used throughout, “one or more” means one or a plurality of; for example, “one or more” may comprise one, two, three, . . . , one hundred, or more. Further, as used throughout, “zero or more” means zero, one, or a plurality of; for example, “zero or more” may comprise zero, one, two, three, . . . , one hundred, or more.

In the present disclosure, the methods, operations, and/or functionality disclosed may be implemented as sets of instructions or software readable by a device. Further, it is understood that the specific order or hierarchy of steps in the methods, operations, and/or functionality disclosed are examples of exemplary approaches. Based upon design preferences, it is understood that the specific order or hierarchy of steps in the methods, operations, and/or functionality can be rearranged while remaining within the scope of the inventive concepts disclosed herein. The accompanying claims may present elements of the various steps in a sample order, and are not necessarily meant to be limited to the specific order or hierarchy presented.

It is to be understood that embodiments of the methods according to the inventive concepts disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. A system, comprising:
a speaker apparatus, comprising:
a speaker apparatus body; and
a removable base, wherein the removable base has a cavity formed within the removable base.

2. The system of claim 1, wherein the removable base has at least two side holes and a bottom hole, wherein the at least two side holes and the bottom hole allow for a flow of a water to flow into and out of the cavity.

3. The system of claim 1, wherein the speaker apparatus body has an exterior shape generally defined by a cone portion and an inverted cone portion, wherein the inverted cone portion lacks a tip portion, wherein the removable base is configured to removably attach to the inverted cone portion.

4. The system of claim 3, wherein the removable base has an exterior shape generally defined by a cylinder, wherein a diameter of the cylinder is less than a diameter of a circle formed by abutting portions of the cone portion and the inverted cone portion.

5. The system of claim 1, wherein the speaker apparatus body comprises at least three speakers configured to output 360-degree audio.

6. The system of claim 5, wherein the speaker apparatus body comprises at least three speakers covers configured to cover the at least three speakers. The system of claim 1, wherein the removable base includes a bottle opener positioned at a bottom of the removable base.

8. The system of claim 1, wherein the speaker apparatus body is water-resistant, shock-resistant, and dust-resistant.

9. The system of claim 1, wherein the speaker apparatus body includes user interface buttons.

10. The system of claim 9, wherein the user interface buttons include a power button, a volume up button, a volume down button, a Bluetooth button, and a light ring button.

11. The system of claim 1, wherein the speaker apparatus body includes a light ring configured to output 360-degree multicolor light.

12. The system of claim 1, wherein the speaker apparatus body comprises a handle at a top of the speaker apparatus body.

13. The system of claim 1, wherein the speaker apparatus body comprises a processor, a battery, and an antenna.

14. The system of claim 13, wherein the speaker apparatus is configured to wirelessly communicate with a mobile computing device.

15. The system of claim 13, wherein the speaker apparatus is configured to wirelessly pair with another speaker apparatus.

16. The system of claim 1, further comprising an inflatable flotation apparatus, wherein the removable base of the speaker apparatus fits into the inflatable flotation apparatus.

17. The system of claim 1, wherein the removable base is threaded.

18. The system of claim 1, wherein the removable base has an exterior shape generally defined by a cylinder.

19. The system of claim 18, wherein an exterior of the removable base has vertical ridges.

20. A speaker apparatus, comprising:
a speaker apparatus body; and
a removable base, wherein the removable base has a cavity formed within the removable base.
